(19) United States
(12) Patent Application Publication
(10) Pub. No.: US 2006/0245415 A1
(43) Pub. Date: Nov. 2, 2006

(54) System for adding PC screen sharing to a telephone call

(76) Inventor: Keith Gerard Krasnansky, Germantown, MD (US)

Correspondence Address: TEXAS INSTRUMENTS INCORPORATED, P O BOX 655474, M/S 3999, DALLAS, TX, 75265, US

(21) Appl. No.: 11/116,011

(22) Filed: Apr. 27, 2005

(51) Int. Cl. H04L 12/66

(52) U.S. Cl. 370/352; 370/465

(57) ABSTRACT

A system for adding a PC screen to a phone call comprising a phone with a “PC-Add” featured adapter and a link to an associated, PC-Add enabled PC. The PC-Add feature comprises a PC-send button, a PC-receive button and PC-Add hardware and/or software for the phone/adapter, PC and network. While on an IP phone call, a PC-Add-enabled sender presses the PC-send adapter button. While on the same call, a PC-Add-enabled receiver presses the PC-receive button on his end. The image on the sender's PC screen is sent to the receiver's PC screen. The invention comprises many embodiments, including a direct link between the phone and PC or a server supported link, transmission directly through the network or indirectly through the phones, a separate phone and PC-Add adapter combination or an integrated unit, conferencing capabilities able to display multiple sent images from multiple senders, and LAN, WAN or Internet network operation.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to the field of multi-media interactive communications. More specifically, the present invention is a system for simply and immediately associating users' PC screens to telephones being used in an ongoing telephone call such that the image of one or more associated PC screens is able to be transmitted to the PC screens of other parties on the call.

### BACKGROUND OF THE INVENTION

It is often desirable to be able to explain a subject using a computer screen while participating in a phone call. The ability to display and manipulate an image while discussing that image has proven itself worthy of inventive effort. Several adaptations of the theme exist in the prior art, however each comes with limitations.

Boss et al. (U.S. Pat. No. 5,758,110) describes a system for application sharing between two computer screens. Using this invention, a caller can initiate a sharing session with a remote call participant. However, this invention is limited in its suitability as a versatile demonstration tool. First, the set up of the shared session is somewhat cumbersome. It requires both users to have access to the application and requires the caller to direct the remote participant to initiate the application independently. Second, the use of the PC is limited to an application that is designed to be shared. Many are not. Also, oftentimes, it is desirable to simply display the contents of a screen to a remote call participant and manipulate the image to facilitate productive discussion. The inventive method of Boss does not facilitate this feature.

Roberts et al. (U.S. Pat. No. 6,295,551) teaches a call center system which permits two parties to jointly browse web content. This system employs an applet which is downloaded from a web site to a user's computer. The applet transmits information about the current view of the web page on the user's screen to a call center representative. The representative is able to manipulate the user's view, thereby rendering useful service to the user. While this is a useful invention, it does not provide the desired ability to easily transmit images from one user's screen to another.

Petty et al. (U.S. Pat. No. 6,337,858) discloses a telephony system which uses the internet to transmit voice communications in a packet-switched manner. This invention permits the telephone to become a network-enabled device.

Miloslavsky et al. (U.S. Pat. No. 6,625,139) discloses a method for simultaneous coordinating IP telephone and data (e.g., image) communications. A user viewer of a web site is either instructed by the site on how to place an IP call to a call center or is called by the call center based on information obtained from an IP call request sent thought the interactive web connection by the user. In both cases, a user and an agent are able to view the same PC screen while on a phone call. While this invention helps close the gap in the ability to link a PC screen to a phone call. It still falls short of the desired implementation. In the first place, the PC screens initiate the contact and the IP phone call follows. Call participants are not able to link the PC screens or their images via the ongoing call. Second, again, the system is limited to specific applications and is limited to a single pair of users. Multi-party conferences involving associated PC screens is not possible.

Henderson et al., in U.S. Pat. No. 6,035,214 discloses a laptop PC with an integrated IP phone. The screen of the PC provides the phone display and the phone may use the same network as the computer normally utilizes. However, there is no embodiment of the invention which teaches that the screens of two or more laptop phones on a connected call may share an image.

Finally, Chen et al, (U.S. Pat. No. 6,809,749) teaches a method for conducting an interactive design conference where graphics files are able to be transmitted from one viewing screen to one or more other screens. This offers another limited ability to set up PC screen image sharing between users and offers no integrated user phone connectivity.

None of the inventions devised to date allow parties on an ongoing telephone conversation to easily and instantaneously integrate a set of two or more PC screens into the call and to transmit an image on a first (or multiple) caller's screen(s) to screens being viewed by a second or multiple additional call participants. It is for this purpose that the inventive concept below described is taught.

### SUMMARY OF THE INVENTION

To satisfy the need for a simple, efficient, on-demand method to add sharing of an image displayed on a viewing screen between callers during a telephone call, an inventive system is disclosed in which a PC screen may be operatively added to an IP phone call so as to facilitate one or more additional callers' understanding of the subject matter being conveyed.

The system comprises a first user's internet protocol (IP) phone and PC which are operatively interconnected to each other and to a local or wide area network. A second user's IP phone and PC are similarly connected to the network. At the push of a send button on the first user's phone, that phone becomes “PC-send” enabled. At the push of a corresponding receive button on the second user's phone, the second user's phone becomes “PC-receive” enabled. With both buttons engaged, the image on the first user's PC screen is sent to and displayed on the second user's PC screen. Additional user's phones may be connected in a similar manner to simultaneously share the first user's image.

In a first embodiment, software in the IP phones obtain the network addresses of their respective PCs. Upon each phone becoming either PC-send or PC-receive enabled, software in each of the phone's respective PCs request either the corresponding receive-from or send-to addresses from the appropriate sending or receiving phones. Then the image on the PC associated with the send-enabled phone is broadcast via the network to all of the PCs associated with receive-enabled phones on the network.

In a second embodiment, software in the PCs and the IP phones permits the PC associated with the send-enabled phone to send its image through that phone, via the ongoing IP phone session, to the receive-enabled phones, and on to their associated PC's. This embodiment takes advantage of any security associations or encryption already established between the associated phones.

In a third embodiment, a server creates the association of the PC to a requested IP phone (via a command from the PC identifying which IP phone the user wishes to associate that PC with). Then when a PC-send button is pushed, an image is sent from the server-associated sending phone/PC combination to any conference-connected receiving phone/PCs.

In another embodiment, PC screens may be split to allow simultaneous images from more than one sending party.

In another embodiment, the network may be the internet.

### BRIEF DESCRIPTION OF THE DRAWINGS

Exemplary embodiments of the invention are discussed hereinafter in reference to the following drawings, in which:

FIG. 1 is a network diagram showing the first embodiment of the invention. This figure shows a direct connection between the IP phone and the associated PC. In this embodiment, the image on the sending PC screen may pass directly to other associated PCs through the network, or may pass through the phones to take advantage of any existing security associations or encryption mechanisms.

FIG. 2 shows an embodiment of the IP phones with the PC-Add featured adapter built in.

FIG. 3 is a flowchart depicting the operation of the first embodiment of the inventive system.

FIG. 4 is a drawing of a PC-receive-enabled PC with the screen partitioned to accept an image sent from a PC-send-enabled PC.

FIG. 5 is a network diagram showing the second embodiment of the invention. This figure shows a conference call set up with three PC-Add enabled phone/PC combinations. Again, in this embodiment, the image on the sending PC screen may pass directly to other associated PCs through the network, or may pass through the phones to take advantage of any existing security associations or encryption mechanisms.

FIG. 6 shows an embodiment of the IP phone with the PC-Add featured adapter built in for the second embodiment with all three PC-Add-enabled phones.

FIG. 7 is a drawing of the third embodiment of the invention depicting a PC-receive-enabled PC with the screen partitioned to accept a plurality of sent images from a plurality of PC-send-enabled PCs.

FIG. 8 is a network diagram showing the fifth embodiment of the invention. This figure shows no direct connection between the PC-Add featured phone and PC combinations.

FIG. 9 is a flowchart describing the operation of the fifth embodiment of the invention. It provides a description of the session with the server facilitating the transfer of images between callers devices.

### DETAILED DESCRIPTION OF PREFERRED EXEMPLARY EMBODIMENTS

The present invention comprises one or a plurality of internet protocol (IP) phones associated with one or a plurality of respectively associated workstations or personal computers (PCs), all of which are operatively interconnected by a network. The IP phones are operatively equipped with the facility to cause the transmission of an image from a source PC associated with one IP phone to one or a plurality of destination PCs associated with the remaining IP phones. The IP phones are collectively referred to as PC-Add featured, or simply PC-Add Phones.

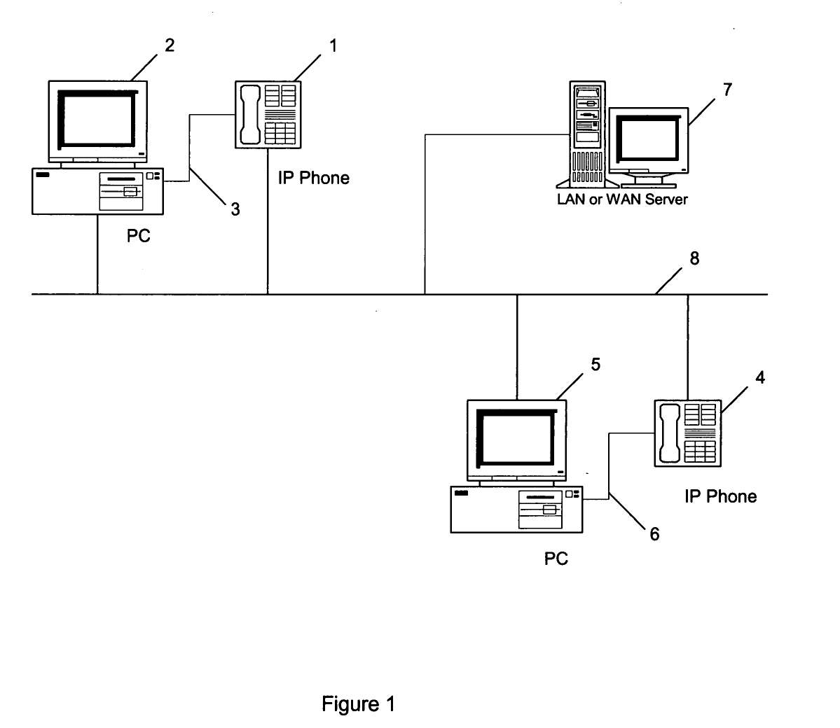

In a first embodiment of the invention, as shown in FIG. 1, a first user's IP phone 1 and a PC 2 are operatively connected and thus associated with each other via interconnection line 3. A second user's IP phone 4 and a PC 5, are also operatively connected and thus associated with each other via interconnection line 6. A server 7 controls transmission of packet traffic on a local or area network 8, which interconnects said phones, PC's and server.

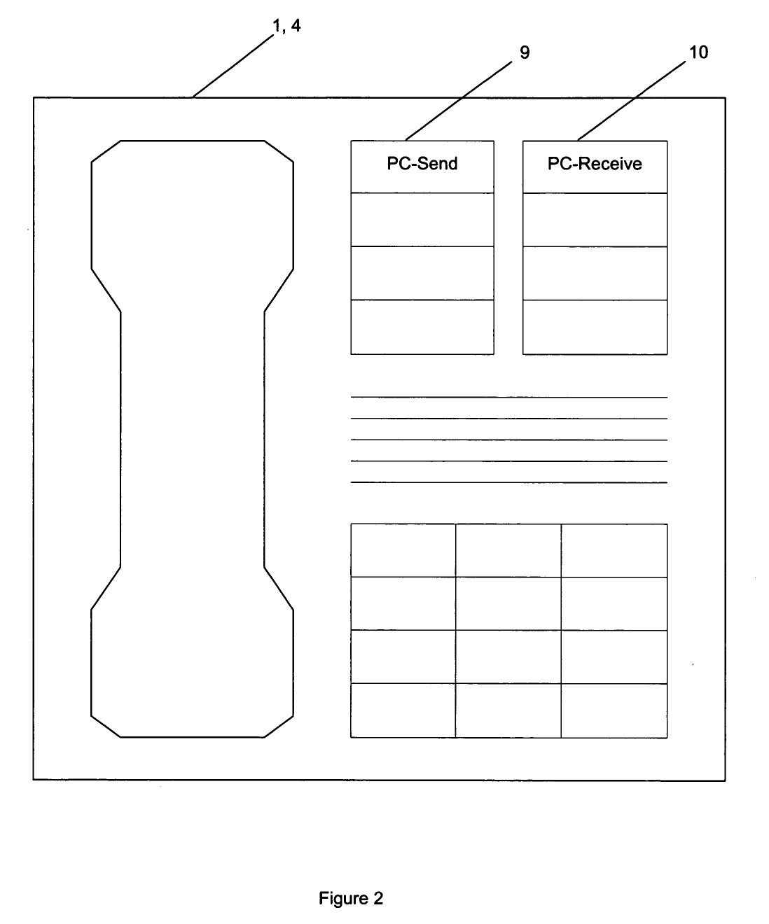

As shown in FIG. 2, IP phones 1 and 4 include two buttons. One is a PC-send button 9 and a PC-receive button 10. Hardware, software or a combination of the two (not shown) within phones 1 and 4 is operatively associated with said buttons. Complementary interfacing software resides within PCs 2 and 5. In this embodiment, either one or the other of the two buttons may be engaged, but not both.

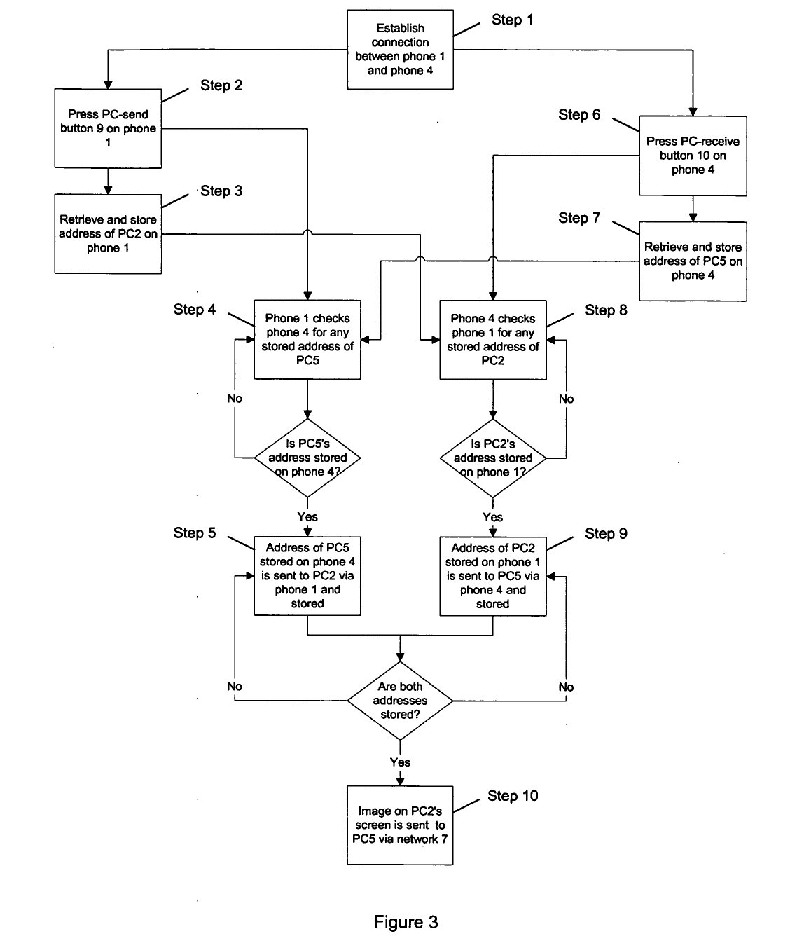

In the first embodiment, and as shown in FIG. 3 an IP phone call is established between phones 1 and 4 (step 1). When PC-send button 9 is pressed on phone (step 2), the phone retrieves the network address of PC 2 (step 3) and stores it in a buffer (not shown) in phone 1. Next, phone 1 checks phone 4 for any stored address (step 4). Any address found on phone 4 is sent to PC 2 via phone 1 and stored (step 5) on PC 2.

Independent of, and in no particular order relative to steps 1-5 above, PC-receive button 10 is pressed on phone 4 (step 6). Phone 4 retrieves the network address of PC 5 (step 7) and stores it in a buffer (also not shown) in phone 4. Next, phone 4 checks phone 1 for any stored address (step 8). Any address found on phone 1 is sent to PC 5 via phone 4 and stored (step 9) on PC 5.

If PC 5's address has been stored on PC 2, PC 2 sends its current image to PC 5 via direct communication over network 7 and server 8. If PC 2's address has been stored on PC 5, PC 5 receives the image from PC 2, also via direct communication on the network. These two events are shown as step 10 in FIG. 3.

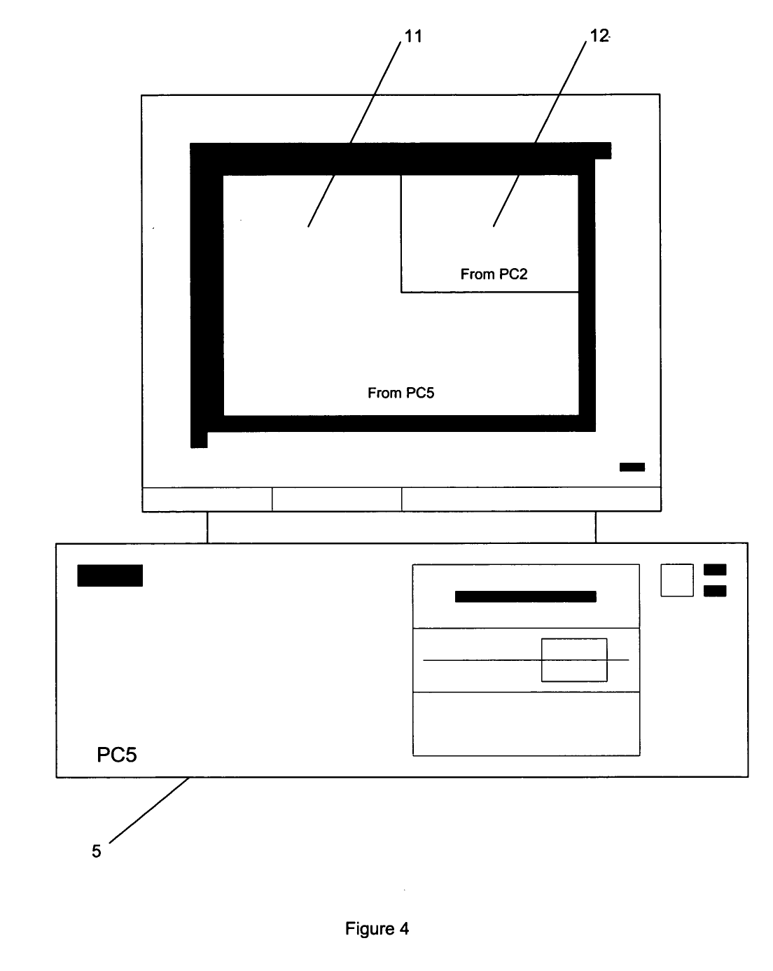

In this embodiment, as shown in FIG. 4, the screen of PC 5 may be split to display both its own current image 11, as well as the image being received from PC 2 12.

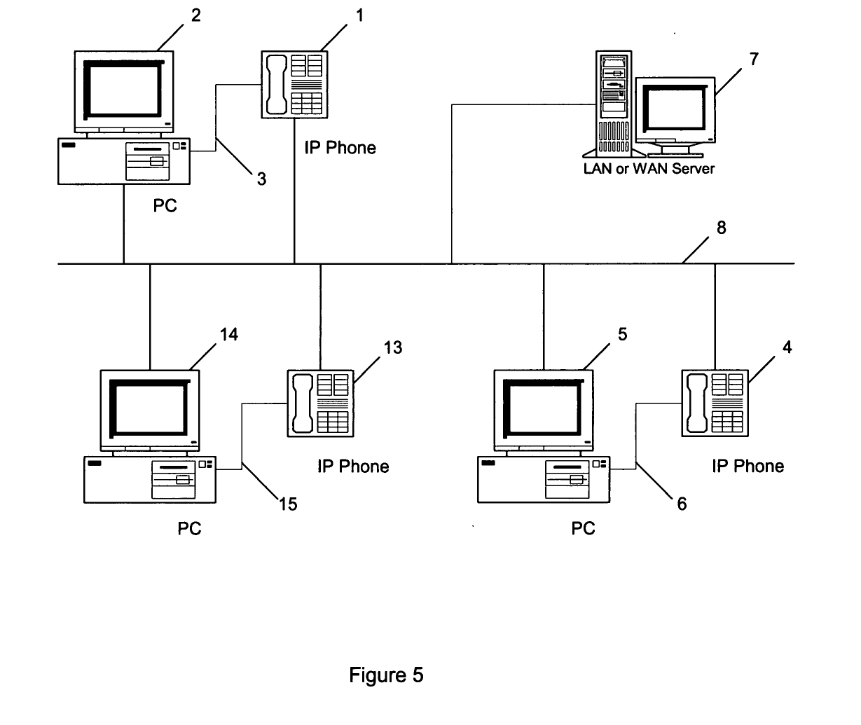

In a second embodiment of the invention, as shown in FIG. 5, a conference call involving three or more PC-Add phones is established. FIG. 5 depicts the same arrangement of FIG. 1 to which is added another PC-Add IP phone 13, PC 14 and interconnecting line 15.

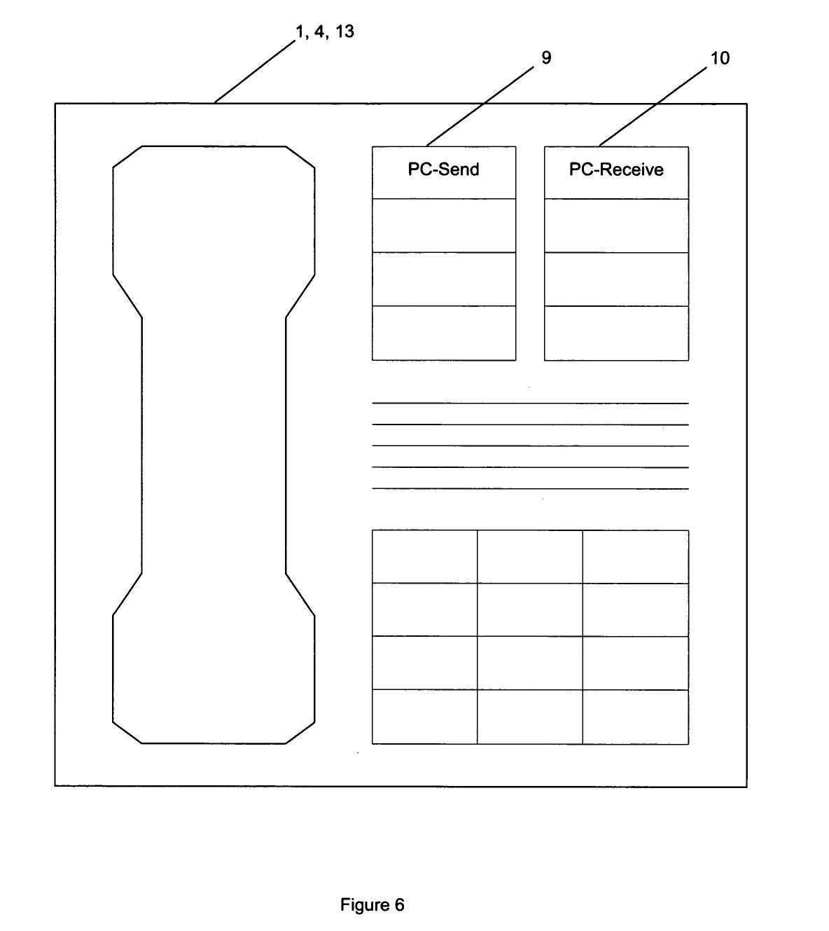

As shown in FIG. 6, new IP phone 13 also includes the PC-send and PC-receive buttons 9 and 10. Again in this embodiment, either one or the other of the two buttons may be engaged, but not both.

In the second embodiment, the process flow as shown in FIG. 3 is repeated, however, steps 6, 7, 8, 9 and 10 which previously involved only receiving phone 4 and PC 5, now also are repeated for receiving phone 13 and PC 14. One reasonably skilled in the art of software development would recognize how adding one or more phone/PC combinations could be added into this embodiment, with the end result being that phone 1 and PC 2 remains the sending combination and that phone 4/PC 5 and new phone 13/PC 14 become two receiving combinations. When PC-send button 9 or PC-receive button 10 is pressed on any phone (steps 2 and 6) the phones each search each other for their associated PC's address information (steps 4 and 8). Once the addresses of any and all such associated conferencing PCs are collected and stored for network transmission purposes on each respective requesting PC (steps 5 and 9), the image of the sending phone's PC is sent via the network to any receiving PC which has been associated with a receive-enabled phone on the conference call (step 10).

Even in multiple party arrangements, the order of pressing send or receive buttons 9 or 10 on any phone in the conference is not important. The inventive software continues to search the phones for indications that other phones are either directing images to be sent to or received by their respective associated machines, and makes adjustments accordingly.

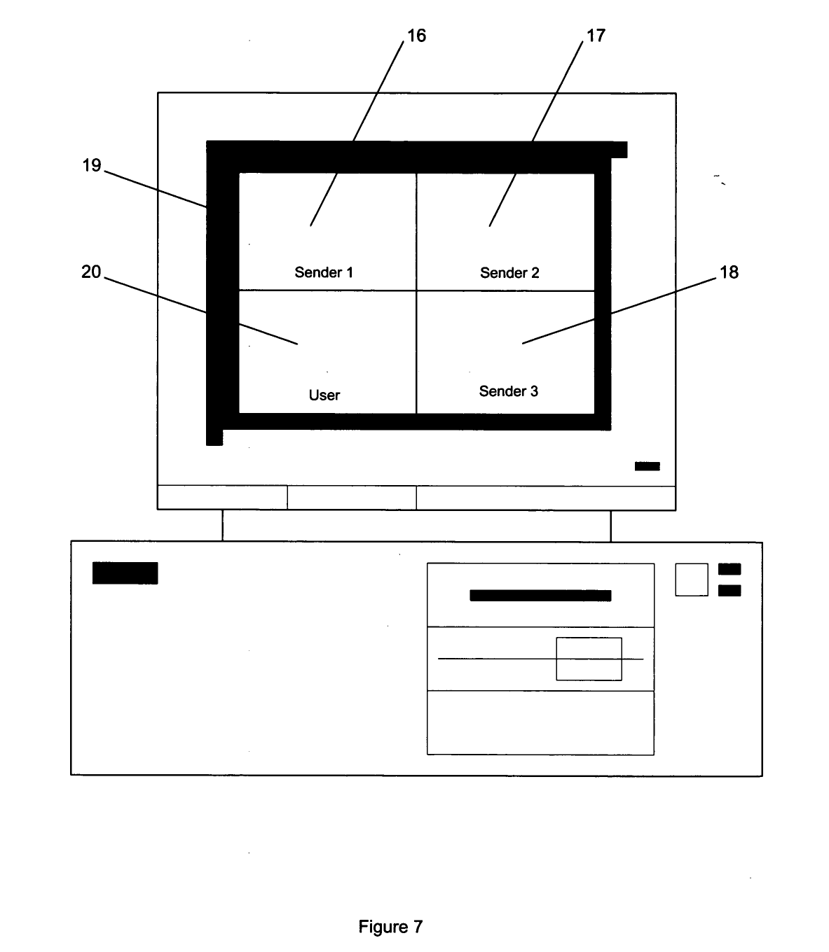

In a third embodiment, the send and receive-enabling hardware, software or combination thereof in the IP phone and PC pairs may facilitate allowing more than one IP phone/PC unit to be send-enabled. In this embodiment, a depiction of which is not shown, more than one PC may be able to send (and, consequently, therefore, to simultaneously receive) an image which the other conferenced PCs are able to receive in separate windows on their screens. In this embodiment, both send and receive buttons on the PC-Add phones may be able to be engaged at the same time. A depiction of a typical PC screen under this arrangement is shown in FIG. 7 where an image from a sender 1 (16), sender 2 (17) and sender 3 (18) is able to be viewed on a user's PC screen 19 while simultaneously displaying the user's PC's own generated image 20.

In a fourth embodiment, the inventive concept continues to include PC-Add IP phones and PCs which are associated with these phones via a direct link and the network. However in this embodiment, once the associations have been made between the phones and the PCs, the image on a sending phone's associated PC screen is sent to the other conferencing parties via the currently established IP phone connection. That is, the image from the PC is transmitted between the PC-Add-enabled phones rather than between the PC's directly as in the previous embodiments. A phone which is not PC-Add enabled, will function as if only a VoP call was in progress.

In this embodiment, any current security associations or encryption mechanisms which are in place between the connected phones may be utilized to similarly protect the PC images transmitted.

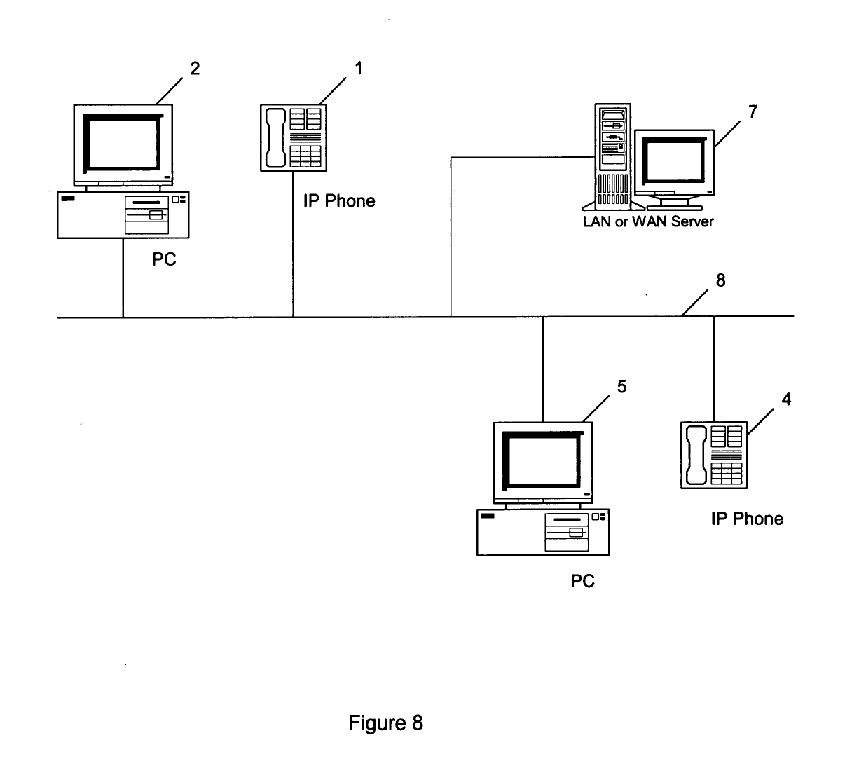

In a fifth embodiment, there is no direct interconnection between the phones and the PCs. As shown in FIG. 8, the inventive system comprises PC-Add IP phones 1 and 4, PCs 2 and 5, server 7 and network 8. PCs 2 and 5 are not necessarily associated with phones 1 and 4. Hardware, software or a combination of the two (not shown) within phones 1 and 4 is operatively associated with PC-send and PC-receive buttons on the phones. Complementary interfacing software resides within PCs 2 and 5, and in server 7. Upon a user-initiated prompt from PC 2, the user requests to associate that PC with phone 1. This association may be made by selection, as from a list of available phones, or by imputing the tag number of the IP phone for which the association is desired. Alternatively, the selection of the PC may be made via the phone, from a list of pre-selected or available devices. Server 7 permits and facilitates the association of the phone with the PC once the selection above is made.

Once the association is made, the user of phone 1 may PC-Add enable his phone by pressing the PC-send or PC-receive button. Other phones on the connection may similarly enable themselves by pressing either of their respective PC-send or PC-receive buttons. Server 7 then controls transmission of both the phone call and the image transfers over network 8.

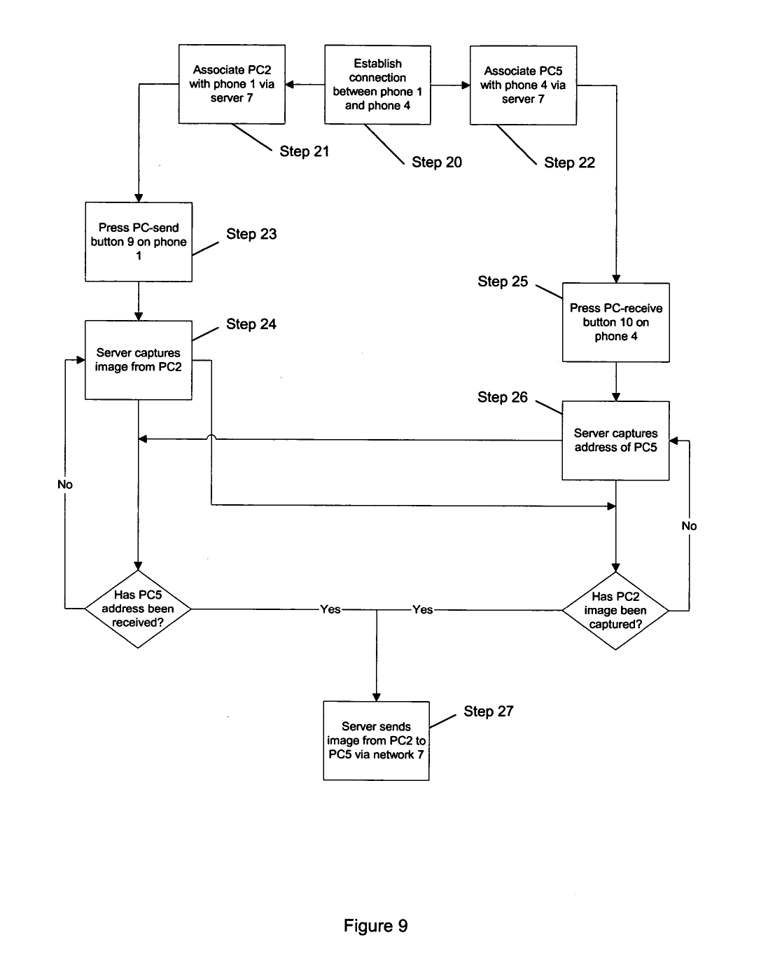

The flowchart of FIG. 9, provides a description of the session. A connection is established between two phones (step 20). PC 2 and PC 5 are associated with respective phones 1 and 4 via independent selection (steps 21 and 22). PC-send button 9 is pressed on phone 1 (step 23). The server captures the image shown on PC 2's screen for transmittal whenever a receive-enabled phone/PC combination is detected (step 24). Independent of, and in no particular order relative to steps 20-24 above, PC-receive button 10 is pressed on phone 4 (step 25). The server captures the address of PC 5 and stores it with other addresses (if any) to which any PC-Add image is to be transmitted (step 26). Note that the server does not have to have a PC-send enabled image captured at this point. Once the server detects that it has a send signal from PC 2 and a receive signal from PC 5, the image from PC 2 is sent, via the network, to PC 5 (step 27).

The server need only detect at least one send signal and one receive signal from a phone/PC pair before it begins transmitting the image. As in previous embodiments, there may be more than two users, more than one user may send and a user may receive more than one image from other PCs. Also, a user may send images and receive one or a plurality of images without departing from the teachings of the invention.

All of the previous embodiments have been described in the context of a telephone with an integrated adapter which adds said PC-send and PC-receive buttons to the function of the phone. However, a separate telephone adapter may be provided without departing from the teachings of the inventive concept.

In several of the above embodiments, the link between the phone and the PC is depicted as a hard-wired link. However, the link may comprise a wireless, infrared or other suitable connection without departing from the inventive idea.

Finally, the previous embodiments have been described in the context of a local or wide area network. However, with proper hardware and/or software adaptation, the network may also comprise the Internet.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A system for adding sharing of an electronic viewing screen to a phone call comprising:
a first telephone;
a second telephone;
a first telephone adaptor operatively interconnected with said first telephone;
a second telephone adapter operatively interconnected with said second telephone;
a first electronic viewing screen;
a second electronic viewing screen;
a first access device controlling said first screen;
a second access devices respectively controlling said second screen;
a packet-switched network, including at least one server, having interconnections between said first and second telephones, said first and second adapters, said first and second screens and said first and second access devices;
a provision within said network to facilitate associations between said first telephone, said first adapter and said first screen, and between said second telephone, said second adapter and said second screen; and
software operating cooperatively among said first and second adapters, said first and second access devices and said network which allows said first and second adapters to respectively involve said associated first and second screens in a telephone call.

2. The system of claim 1 wherein said first and second adapters comprise an electronic unit with a PC-Add feature, said feature comprising a PC-send button, a PC-receive button, and a feature processing unit (FPU) operating on said software.

3. The system of claim 2 wherein said first and second screens may be partitioned to maintain an image respectively from said first and second devices and to simultaneously maintain one or a plurality of images received from said network.

4. The system of claim 3 wherein engaging said PC-send button on said first adapter and engaging said PC-receive button on said second adapter sends a first image from said associated first screen across said network to said second screen associated with said second adapter.

5. The system of claim 3 wherein engaging said PC-send button on any of said first or second adapters creates a set of PC-send-enabled adapters, and wherein engaging said PC-receive button on any of said first or second adapters creates a set of PC-receive-enabled adapters, and wherein respective images from screens associated with each PC-send-enabled adapter are sent across said network to screens associated with each PC-receive-enabled adapter.

6. The system of claim 1 wherein said interconnection of any of said first or second telephones to any of said respective first or second adapters may be by one of direct link or physical integration.

7. The system of claim 1 wherein said interconnection of any of said first or second adapters to any of said respective first or second access devices may be by one of indirect network-linked, direct link, wireless and infrared.

8. The system of claim 1 wherein said provisioning of said network to facilitate said associations comprises associating said first and second access devices to said respective first and second adapters by direct selection at either said adapters or said access devices and association thereof via an algorithm within said server.

9. The system of claim 1 wherein said provisioning of said network to facilitate said associations comprises a direct link between each of said first and second adapters and each of said first and second access devices, respectively.

10. The system of claim 1 wherein said telephone may be one of a public switched telephone network (PSTN) phone or an internet protocol (IP) phone.

11. The system of claim 1 wherein said access device may be one of a personal computer central processing unit (PC CPU) or a workstation terminal.

12. The system of claim 1 wherein said network comprises one of a local area network (LAN), a wide-area network (WAN) or the Internet.
